(19) United States
(12) Patent Application Publication
(10) Pub. No.: US 2024/0408801 A1
(43) Pub. Date: Dec. 12, 2024

(54) APPARATUS AND METHOD FOR MOLDING AND PRESSING A CLOSURE COMPRISING FIBERS

(71) Applicant: Krones AG, Neutraubling (DE)

(72) Inventor: Frank WINZINGER, Regensburg (DE)

(21) Appl. No.: 18/736,272

(22) Filed: Jun. 6, 2024

(30) Foreign Application Priority Data
Jun. 6, 2023 (DE) 102023114889.3

(51) Int. Cl. B29C 43/04; B29C 43/32; B29K 105/06; B29L 31/56; B65B 3/02; B65B 7/01

(52) U.S. Cl. CPC B29C 43/04; B65B 3/022; B65B 7/01; B29C 2043/325; B29C 2043/3283; B29K 2105/06; B29L 2031/56

(57) ABSTRACT

Embodiments for an apparatus for molding and pressing a closure comprising fibers, in particular pulp, are disclosed herein. In an example, the apparatus comprises a mold wherein the closure is to be at least partially molded and which has an opening, a mandrel, in particular for insertion into the opening, at least temporarily and/or partially within the mold, wherein the mandrel comprises a structure for molding the closure, movement means for executing a relative movement, such as a radial relative movement in relation to a longitudinal axis of the mandrel, between the mold and the mandrel for reducing a distance from the mold and the mandrel and thus for molding and pressing the closure. The disclosure further relates to a method of molding and pressing a closure comprising fibers using the apparatus.

### CROSS REFERENCE TO RELATED APPLICATION

The present application claims priority to German Patent Application No. 10 2023 114 889.3 filed on Jun. 6, 2023. The entire contents of the above-listed application are hereby incorporated by reference for all purposes.

### TECHNICAL FIELD

The disclosure relates to an apparatus and a method for molding and pressing a closure comprising of fibers, in particular pulp. The disclosure further relates to a filling system including the apparatus.

### BACKGROUND

When producing closures from fibers, in particular pulp, there are high demands on strength and stability. It is known, for example, that a plastic closure is subsequently attached to the pulp molded closure.

### SUMMARY

### Problem

The object of the disclosure is to provide an apparatus and a method that enable the formation of a dimensionally stable closure comprising fibers, in particular pulp, and integrate it into the filling process.

### Solution

In an example, the above-described object may be achieved with an apparatus for molding and pressing a closure comprising fibers (e.g., pulp), wherein the apparatus comprises: a mold in which the closure is to be at least partially molded and which has an opening, a mandrel at least temporarily and/or partially within the mold, the mandrel comprising a structure for molding the closure, and movement means for executing a relative movement between the mold and the mandrel to reduce a clearance of the mold and the mandrel, and thus to form and press the closure.

The apparatus can be used to mold the closure comprising the fibers with high precision and stability. In addition, the residual moisture of the closure can be reduced by the molding process, in particular by the relative movement of the movement means, so that subsequent drying is no longer necessary or only necessary for a shorter time. This improves the quality of the closures and the efficiency of the apparatus. Furthermore, the molding of the closure comprising fibers and the filling can take place in one system.

In particular, the fibers are, at least in part, plant fibers. Pulp may comprise a suspension of water and fibers. The fibers can comprise lignin, banana leaves, quinine, glass fibers, metal threads and/or sutures. The fibers can comprise, for example, fibers from coniferous woods, leafy woods, and/or sycamores, and/or from grasses, reeds, and/or bamboo, or the like. Lignin can have a supportive effect on the cellulose and may also be suitable for transparent applications. Banana leaves can be suitable for larger containers, such as single use tableware. An improvement in the strength can be achieved by embedding glass fibers, metal threads and/or sutures.

The closure can have an internal diameter of 0.1 cm to 10 cm, for example of 1.5 cm to 6 cm. In the case of fibers, the closure can have an internal diameter of up to one meter.

In the forming of the opening of the closure, the mandrel can already be arranged in said opening or contribute to the formation of the opening, or alternatively can be introduced into the opening only after said opening has been formed.

In particular, the mandrel can be inserted along its longitudinal axis so that the longitudinal axis of the mandrel corresponds to the direction of movement of the mandrel when it is inserted into the opening.

For example, the raw version of the closure may not comprise a thread and/or engagement elements. A thread and/or engagement elements can, for example, be shaped and pressed, and thus be molded, for example, by means of the structure of the mold.

Executing the relative movement can mean that the mold can be designed to be movable by means of the movement means, whereas the mandrel can be designed to be stationary.

Alternatively, the execution of the relative movement can mean that the mandrel can be designed to be movable by means of the movement means, whereas the mold can be designed to be stationary. The mandrel can be designed in multiple parts, for example, wherein one or more of the parts can be designed to be movable.

Alternatively, it can be provided that the execution of the relative movement can mean that both the mold and the mandrel can be designed to be movable by means of the movement means. The mandrel can be designed in multiple parts, for example, wherein one or more of the parts can be designed to be movable.

The clearance of the mold and the mandrel can be reduced, using the movement means, to form and press the closure. It can be provided that the movement means for executing a relative movement between the mold and the mandrel can be further designed to increase a clearance of the mold and the mandrel. For example, after completion of the closure, via the molding and pressing, the mold and the mandrel can be removed from one another so that the closure arranged between them can be removed. It can be provided that the mandrel can be extracted from an opening of the closure after completion of said closure.

A pressure during pressing can be in a range of from 10,000 N/m² (0.1 bar) to 100,000,000 N/m² (1,000 bar), for example from 100,000 N/m² (1 bar) to 10,000,000 N/m² (100 bar) or, for example, from 500,000 N/m² (5 bar) to 5,000,000 N/m² (50 bar) so that the molded closure is especially stable and durable.

The mold can be in one piece or in multiple parts. Accordingly, the structure can be in one or more parts.

For example, to mold and press a closure with round cross-section, the mandrel and the mold can comprise substantially circular-cylindrical cross-sections.

The structure can comprise a negative mold of a thread to be molded and/or of engagement elements to be molded. This allows the molded closure to be connected to a corresponding container.

The relative movement can comprise a movement of the mold in the direction of the mandrel, or away from the mandrel. The movement can be provided radially toward the mandrel or radially in the direction away from the mandrel. Radially can mean with respect to a longitudinal axis of the mandrel or the direction of movement of the mandrel when it is inserted into the opening. This means that the closure can first be molded under pressure and then removed from the mold.

The relative movement can comprise a movement of the mandrel in the direction of the mold, or away from the mandrel. This means that the closure can also first be molded under pressure and then removed from the mold.

The mold can comprise a structured outer surface in the form of elevations and/or depressions, in particular grooves. When executing a relative movement using the movement means between the mold and the mandrel to reduce the distance from the mold and the mandrel, the mold comprising the structure can contact the closure and it can press against the structured shell surface so that the closure can be molded and pressed, whereby the closure can be more easily opened manually or separated from the corresponding container by the structured surface.

The movement means may comprise one or more radially movable jaws on the mold or on the mandrel. The mandrel or the mold can comprise at least two radially movable jaws, wherein, for example, two radially movable jaws can be provided, which can each comprise a cylinder segment of approximately 180°, or wherein, for example, four radially movable jaws can be provided, which can each comprise a cylinder segment of approximately 90°. Three jaws of approximately 120° would also be conceivable. In order to be able to ensure a relative mobility of the jaws, these can respectively extend (over their entire height) less (e.g., 0.05° to 5°) than 360°/(number of jaws) of the circumference.

In an alternative embodiment, the jaws can overlap partially in the circumferential direction, at least at their edges. The overlap can, for example, be formed by means of a plurality of projections along the height in the manner of a zipper. Thus, projections of one jaw can engage between projections of the adjacent jaw. This can result in that at least one jaw, for example all jaws, extends in the circumferential direction by more than 360°/(number of jaws). For example, three jaws could be provided which each extend by 125° in the circumferential direction.

For molding and pressing the closure, the radially movable jaws can be moved radially away from a longitudinal axis of the mandrel, for example.

Upon executing a relative movement using the movement means between the mold and the mandrel to reduce the clearance of the mold and the mandrel, the movable jaws can contact the closure and can press it against the mold so that the closure can be molded and pressed.

It may occur that, due to the radial movement away from the longitudinal axis of the mold, portions of the closure cannot be contacted by one of the radially movable jaws. The mold can therefore be rotated by an angular range about the longitudinal axis of the mandrel, wherein the angular range can be unequal to an angle size of a cylinder segment of the jaw. For example, a rotation by 45°, 135°, 225°, or 315° can be provided in the event of angle sizes of the cylinder segments of 90° in each case. By rotating the mandrel, burrs on the lateral surface of the closure can be avoided. Instead, it can be provided that, after a first molding and pressing process, the radially movable jaws can first be moved radially away from the longitudinal axis of the mandrel before the mold can be rotated by an angular range about the longitudinal axis of the mandrel, wherein the angular range can be unequal to an angle size of a cylinder segment of the jaw.

After execution of the rotation, to mold and press the closure the radially, movable jaws can again be moved radially towards a longitudinal axis of the mandrel, for example, so that—upon execution of a relative movement using the movement means between the mold and the mandrel to reduce the clearance of the mold and the mandrel—the movable jaws can contact the closure and can press it against the mandrel so that the closure can be molded and pressed.

The jaws of the mandrel can also be rotated between two pressing processes along an angular range of the longitudinal axis of the mandrel that does not correspond to the angular sizes of the cylinder segments. There may also be a relative movement in the direction of the longitudinal axis of the mandrel, which may correspond in particular to the thread path of the negative mold of the structure.

Additionally or alternatively, the movement means may comprise a spreading rod, expansion sleeve, hydraulics, or one or more toggles/toggle levers coupled to a rod. Respectively at least one inclined plane can be provided on a rear side of the lateral surface segments, and the mandrel or the mold further comprises a spreading rod that is movable parallel to the longitudinal axis of the mandrel, wherein an interaction of the at least one inclined plane and the spreading rod can produce a radial movement of the radially movable jaws. The radially movable jaws can be moved, for example radially away from a longitudinal axis of the mandrel, by the interaction of the at least one inclined plane and the spreading rod to mold and press the closure. Upon executing a relative movement using the movement means between the mold and the mandrel to reduce the clearance of the mold and the mandrel, the movable jaws can contact the closure and can press it against the mold so that the closure can be molded and pressed. As described previously, a rotation of the mandrel about its longitudinal axis and/or relative movement along its longitudinal axis can also be provided.

The mandrel or mold may include hydraulics which, in conjunction with the radially movable jaws, may cause radial movement of the radially movable jaws to contact the closure and press it against the mold or mandrel.

The mandrel or the mold can comprise at least one toggle per radially movable jaw, wherein an interaction of the at least one toggle and the radially movable jaw can produce a radial movement of the radially movable jaw. The previously described interactions of closure, jaws, and mold can also apply here. It can also be provided that, as described above, the mandrel or the mold can be designed to be rotatable about the longitudinal axis of the mandrel.

The apparatus can further comprise rotary means for executing a rotation of the mandrel or the mold about the longitudinal axis of the mandrel. The rotary means may include a motor.

The problem is also solved by a method for molding and pressing a closure comprising fibers, the method comprising: providing a closure comprising fibers at least partially in a mold, the mold comprising an opening in which a mandrel is arranged at least temporarily and/or partially, optionally inserting the mandrel into the opening, and executing a relative movement between the mold and the mandrel using a movement means to reduce a clearance of the mold and the mandrel, and thereby molding and pressing the closure.

The process can be used to mold the closure comprising the fibers with high precision and stability. In addition, the residual moisture of the closure can be reduced by the molding process, in particular by the relative movement of the movement means, so that subsequent drying is no longer necessary or only necessary for a shorter time. This can improve the quality of the closures and the efficiency of the method.

The execution of the relative movement to reduce the clearance may comprise:
moving the mold, by means of the movement means, radially in the direction of the mandrel, for example radially in the direction of a longitudinal axis of the mandrel, wherein the mandrel is stationary, or
moving the mold, using the movement means, radially in the direction of the mold, for example radially away from the longitudinal axis of the mandrel, wherein the mold is stationary, or
moving the mold, using the movement means, in the direction of the mandrel, for example radially in the direction of a longitudinal axis of the mandrel, and moving the mandrel, using the movement means, in the direction of the mold, for example radially away from the longitudinal axis of the mandrel.

This allows the closure to be contacted and molded between the mandrel and the mold.

In addition, features as have already been mentioned with regard to the apparatus in connection with the execution of the relative movement for reducing the clearance are also applicable to the method, since the method can be used for this apparatus.

The method may further comprise moving the radially movable jaws of the mandrel away from a longitudinal axis of the mandrel or the radially movable jaws of the mold towards a longitudinal axis of the mandrel. This applies to an embodiment of the apparatus in which the mandrel or the mold can comprise at least two radially movable jaws with planar lateral surface segments, as have already been described further above. Features, as have already been made with respect to the mandrel or the mold with radially movable jaws in connection with the apparatus, are also applicable to the method, since the method uses this apparatus.

The method can further comprise a rotation of the mandrel or the mold by an angular range. For example, moving the radially movable jaws of the mandrel or the mold toward the longitudinal axis of the mandrel can be provided before the rotation. Moving the radially movable jaws of the mandrel away from the longitudinal axis of the mandrel can then be provided after the rotation.

Here, too, features as were already made in connection with the device are applicable to the method.

The method can further comprise, for example after the molding and pressing of the closure, a movement of the mold away from the longitudinal axis of the mandrel and/or a movement of the radially movable jaws of the mandrel toward the longitudinal axis of the mandrel, if the mandrel comprises radially movable jaws. The mold and/or the radially movable jaws can thereby be removed from the molded and pressed closure. The closure containing fibers, in particular pulp, can then be fed to further processing steps, for example.

After molding, the mandrel can be designed to transport and/or hold the closure. The closure can thus be taken over by other handling devices, for example. During retention or transport, a lower pressure can be exerted by the jaws.

Upon pressing, as much of the liquid fraction of the fibers, for example of the pulp, as possible can be pressed out, so that the closure has only a low residual moisture content.

The closure can comprise one or more or all of the following characteristics:
a latching element that is attached to the closure and is designed so that the closure ring of a container can latch into place,
a negative mold of a thread for screwing onto a container,
a sign, for example in the form of a number, for identifying the mold or the mandrel with which the closure was pressed.

When molding a closure, the structure of the mandrel has an external thread in particular. The external thread can also be arranged on the jaws described. The end face of the mandrel can form the shape of the inside of the end face of the closure.

The outer mold used to produce the closure can be profiled, for example it can have grooves or slots extending along the height direction to make it easier for a person to twist the closure open. The height direction extends parallel to the center axis formed by the thread of the closure.

The apparatus can especially have a plurality of similar molds and mandrels in order to be able to simultaneously produce a plurality of closures.

Furthermore, in addition to said molds, the apparatus may comprise precoat molds in which the basic shapes of the closures to be formed are formed (without such high pressure), whereupon the basic shapes are transported by a handling device into the molds according to the disclosure. Alternatively, the closures to be molded can be molded in the mold according to the disclosure from an unshaped mass comprising fibers.

The apparatus can further comprise a mixer with which the mass (e.g., pulp) can be produced. The device can comprise a pump which can pump the mass toward the mold.

The mold and/or the mandrel can have holes through which the expressed liquid can be discharged. The holes can be bores or pores of the material of which the mold and/or the mandrel consist, at least partially. Furthermore, channels for discharging the liquid can be arranged within the mandrel and/or the mold.

The apparatus disclosed herein may be included as part of a filling system. The filling system can also be configured as a beverage filling system. The filling system can also comprise a second transport apparatus for transporting the containers.

The method may further comprise one or more of the following steps:
Molding and pressing of a container
Transporting the container to a filling device
Filling the container
Closing the container with the closure, in particular by screwing it on
Transporting the closure to a closure apparatus (third apparatus for applying the closure)
Coating the closure and/or container before closing or coating the container before filling.

### BRIEF DESCRIPTION OF THE FIGURES

The accompanying figures show, by way of example, aspects and/or exemplary embodiments of the disclosure for better understanding and illustration. In the figures:

FIG. 1 shows a schematic semi-longitudinal section of a first embodiment of an apparatus for molding and pressing a closure comprising fibers,

FIG. 2 shows a schematic partial longitudinal section of a second embodiment of an apparatus for molding and pressing a closure comprising fibers,

FIG. 3A shows a schematic plan view of a first arrangement of mold and mandrel for molding and pressing a closure,

FIG. 3B shows a schematic plan view of a second arrangement of mold and mandrel for molding and pressing a closure,

FIG. 3C shows a schematic plan view of a third arrangement of mold and mandrel for molding and pressing a closure,

FIG. 3D shows a schematic plan view of a fourth arrangement of mold and mandrel for molding and pressing a closure,

FIG. 4A shows a schematic semi-longitudinal section of a second embodiment of an apparatus for molding and pressing a closure comprising fibers, in a first arrangement, and

FIG. 4B shows a schematic semi-longitudinal section of the second embodiment of the apparatus in a second arrangement.

FIG. 4C shows a schematic semi-longitudinal section of the second embodiment of the apparatus in a third arrangement.

FIG. 5A shows a schematic semi-longitudinal section of the second embodiment of the apparatus with a first embodiment of the material insertion,

FIG. 5B shows a schematic semi-longitudinal section of the second embodiment of the apparatus with a second embodiment of the material insertion, and

FIG. 5C shows a schematic semi-longitudinal section of the second embodiment of the apparatus with a first example of material insertion.

FIG. 6 shows a filling system in a first embodiment.

### DETAILED DESCRIPTION OF THE FIGURES

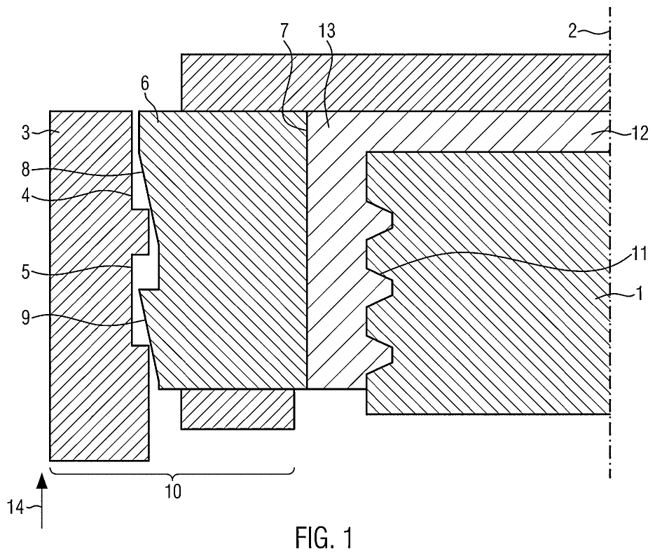

FIG. 1 shows a schematic semi-longitudinal section of a first embodiment of an apparatus for molding and pressing a closure 13 comprising fibers.

In the sectional representation, the mold 10 comprises a radially movable jaw 6 with a lateral surface segment 7, on the rear side of which are provided two inclined planes 8, 9 arranged one above the other as seen along the longitudinal axis 2 of the mandrel 1. In the sectional representation, the mold 10 further comprises a spreading rod 3 that can be moved parallel to the longitudinal axis 2 of the mandrel 1. The spreading rod 3 comprises, on its surface which points toward the jaw 6, two recesses 4, 5 arranged one above the other as seen along the longitudinal axis 2 of the mandrel 1. In the event of a movement of the spreading rod 3 parallel to the longitudinal axis 2 in a direction 14 of the end face 12 of the closure 13, an interaction of the inclined planes 8, 9 and the recesses 4, 5 causes a radial movement of the radially movable jaw 6 in the direction toward the mandrel 1. Alternatively, the recesses 4, 5 can likewise have inclined planes or rolling bodies for moving on the inclined planes (not shown). In a further alternative (not shown), the mold 10 can comprise rolling elements, recesses, or inclined planes only at one height. Two, three, or more rolling elements, recesses, or inclined planes can be arranged in the circumferential direction.

The mandrel 1 and the structure 11 for molding the closure 13 are located at least partially inside the closure 13 during the pressing process. Due to the radial movement of the jaw 6 in the direction toward the mold 10, the clearance between the jaw 6 and the mold 10 decreases and the closure 13 can be pressed into the structure 11 of the mold, and the closure 13 can thus be molded or finished.

Above and below the jaw 6, you can see guides for the jaw movement that are not labeled with position markers.

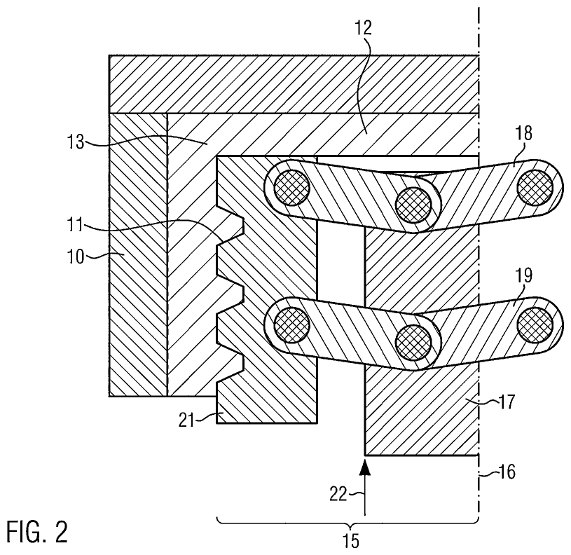

FIG. 2 shows a schematic partial longitudinal section of a second embodiment of an apparatus for molding and pressing a closure 13 comprising fibers.

In the sectional depiction, the mandrel 15 comprises a radially movable jaw 21 with a structure 11 and a rod 17, which is connected to the jaw 21 with two toggle levers 18, 19. In the event of a movement of the rod 17 parallel to the longitudinal axis 16 of said rod 17 in a direction 22 to the end face 12 of the closure 13, an interaction of the toggle levers 18, 19 with the jaw 21 causes a radial movement of the radially movable jaw 21 in the direction toward the mold 10.

Due to the radial movement of the jaw 21 in the direction toward the mold 10, the clearance between the jaw 21 and the mold 10 decreases and the closure 13 can be pressed into the structure 11 of the mandrel 1, and the closure 13 can thus be molded or finished.

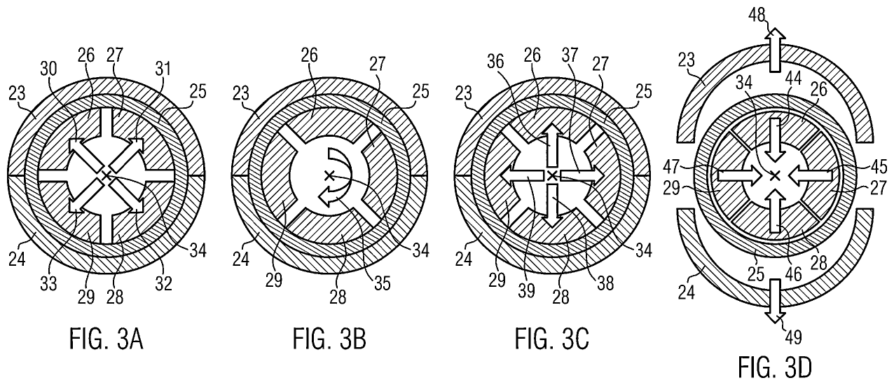

FIG. 3A shows a schematic plan view of a first arrangement of mold and mandrel for molding and pressing a closure. The mold comprises two parts 23, 24, which surround a closure 25 comprising fibers. The four radially movable jaws 26, 27, 28, 29 of the mandrel are only shown as examples for the sake of clarity.

Radial movement of the jaws 26-29 in the directions 30-33 can be executed, for example, by means of the elements of the embodiments shown in FIGS. 1 and 2, with the mechanism of FIG. 1 being applied to the mandrel instead of the mold. In FIG. 3A, the jaws 26-29 are moved radially away from a longitudinal axis 34 of the mandrel. The clearance between the mold and the jaws 26-29 can thereby be reduced, whereby the closure 25 can be molded by pressing of the mold into a structure (not shown).

Due to the radial movement away from the longitudinal axis 34, portions of the closure 25 are not contacted by the four jaws 26-29. The mandrel can therefore be rotated by an angular range about its longitudinal axis, wherein the angular range can be unequal to an angle size of a cylinder segment of the jaws 26-29. By rotating the mandrel, burrs in the interior of the closure 25 can be avoided. Depending on the shape of the structure of the lateral surfaces of the jaws 26-29 of the mandrel, in particular in the case of threads or negative threads, a relative movement in the direction of the longitudinal axis 34 of the mandrel can also take place in addition to the rotation about the longitudinal axis 34 of the mandrel.

Furthermore, if a thread is to be impressed by the rotating mandrel, the mandrel could be replaced by another mandrel with an adapted structure on the lateral surface for the second pressing process.

FIG. 3B shows a schematic plan view of a second arrangement of mold and mandrel for molding and pressing a closure 25. The radial movement of the jaws 26-29 away from the longitudinal axis 34 was stopped, and the mandrel was rotated by 45° in the clockwise direction 35 about the longitudinal axis 34.

Generally speaking, an inner and/or outer mold 10, 23, 24, 26-29 can rotate between two pressing processes by an angle relative to the closure 25 to be molded, wherein the angle is dimensioned such that, in the second pressing process, a molded part is situated at the position, which was arranged between two molded parts in the first pressing process.

FIG. 3C shows a schematic plan view of a third arrangement of mold and mandrel for molding and pressing a closure. After the end of the rotation by 45° in the clockwise direction 35 about the longitudinal axis 34, the jaws 26-29 are again moved radially away from the longitudinal axis 34 in the directions 36-39, and the closure 25 can be molded by re-pressing into the structure of the mandrel.

The position of the two parts 23, 24 of the mold is not changed.

FIG. 3D shows a schematic plan view of a fourth arrangement of mold and mandrel for molding and pressing a closure. After the molding and pressing of the closure 25, i.e., for example after its completion, the one part 23 of the mold can be moved radially away from the longitudinal axis 34 in a direction 48, and the other part 24 of the mold can be moved radially away from the longitudinal axis 34 in a direction 49, in order to form a clearance with respect to the closure 25. In addition, the jaws 26-29 can in each case be moved radially toward the longitudinal axis 34 in a direction 44, 45, 46, 47 in order likewise to form a clearance with respect to the closure 25.

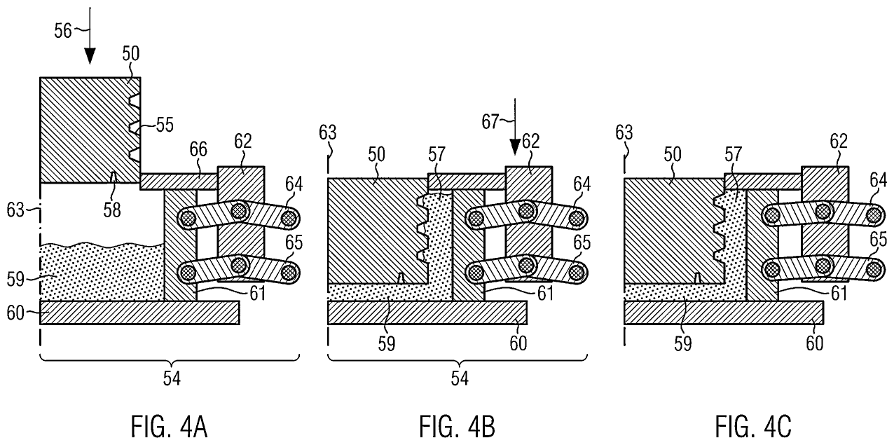

FIGS. 4A to 4C show a schematic semi-longitudinal section of a second embodiment of an apparatus for molding and pressing the fibers 59 into a closure 57 in three arrangements.

FIG. 4A shows that in the first arrangement of the second embodiment, the fibers 59 are already in the mold 54. Now the mandrel 50 is inserted into the mold 54 along the direction 56 or the longitudinal axis 63 of the mandrel, so that the fibers 59 are molded into a closure 57. There is a structure 55 on the mandrel 50 for molding a negative shape of a thread to be molded and/or of engagement elements to be molded on the closure and, in particular, a groove 58 for receiving a sealing material, which can already be applied to the mandrel before the pressing process or can be applied to the closure 57 in an intermediate step.

Furthermore, the mold 54 comprises an end face 60, a radially movable jaw 61, a rod 62, a lateral guide piece 66 and toggle levers 64 and 65 arranged one above the other in the direction of the longitudinal axis 63 of the mandrel 50.

FIG. 4B shows in a second arrangement of the second embodiment that the mandrel 50 has been moved so far in the direction of the longitudinal axis 63 of the mandrel that the fibers 59 have been displaced and the closure 57 has been molded, leaving an end face of the closure 57. Furthermore, it can be seen that the fibers 59 have not yet been fully inserted into the structure 55 of the mandrel 50. Now the rod 62 is moved in direction 67, which is parallel to the direction of the longitudinal axis 63 of the mandrel, whereby the toggle levers 64 and 65 press the movable jaw 61 in the direction of the mandrel 50.

FIG. 4C shows in a third arrangement of the second embodiment how, with the aid of the movements of the rod in direction 67, the toggle levers 64 and 65 are rotated and the movable jaw 61 is pressed in the direction of the mandrel 50, whereby the fibers of the closure 57 are now completely pressed into the contour of the structure 55.

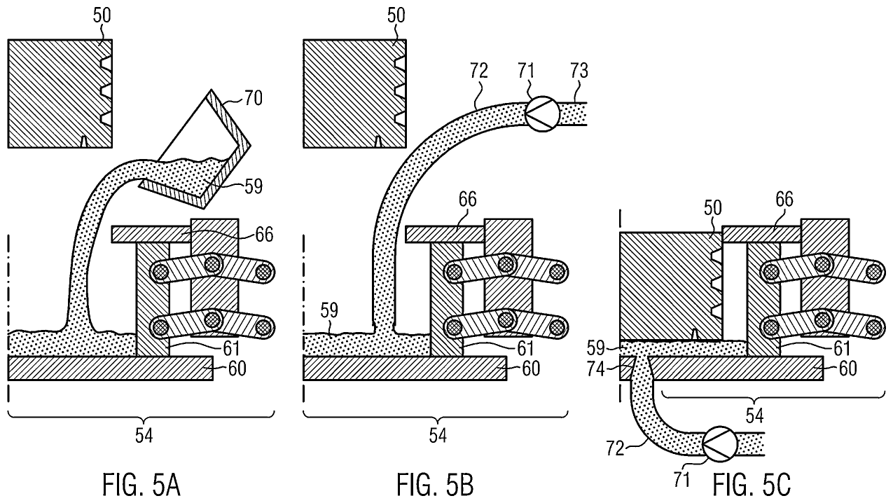

FIGS. 5A to 5C show three different embodiments of the insertion of material into the apparatus in accordance with the second embodiment. However, the three embodiments of the material insertion can also be combined with the apparatus in accordance with the first embodiment.

FIG. 5A shows a first embodiment of the material insertion, in which the fibers 59 are inserted into the mold 54 using a fiber container 70. The fiber container 70 can be used beforehand to prepare the fibers 59 for the pressing process, in particular to mix the fibers 59 with a liquid. The mold 54 can comprise an end face 60, a radially movable jaw 61 and a lateral guide piece 66. The mandrel 50 can be moved out of the mold 54 so that the fibers 59 with the fiber container 70 can be poured into the opening of the mold 54, into which the mandrel 50 is also inserted.

FIG. 5B shows a second embodiment of the material insertion, in which the fibers 59 can be introduced into the mold using a pump 71. Here, the fibers 59 can be introduced with a first piece of tubing 72 from the pump 71 through the opening of the mold 54, through which the mandrel 50 is also inserted. In addition, a second piece of tubing 73 can be used to connect the pump 71 to a pulp mixer (not shown). In this way, the fibers 59 can be inserted into the mold 54 in a particularly time-efficient manner, making the production process more effective.

FIG. 5C shows a third embodiment of the material insertion, in which the fibers 59 can be pumped into the mold 54 by a pump 71 through a check valve 74. In this case, the pump 71 can be connected to the mold 54 with a first piece of tubing 72 via the check valve 74, which can be located in the end face 60 of the mold 54. The pump 71 can thus press the fibers 59 into the mold 54 even if the mandrel 50 has already been inserted into the mold 54. The check valve 74 prevents the fibers 59 from escaping later due to excess pressure inside the mold 54. Furthermore, the pump 71 can be connected to a pulp mixer (not shown) via a second piece of tubing 73. With the material insertion in accordance with the third embodiment example, the fiber insertion can be flexibly integrated into the pressing process of the closure, since fibers 59 can still be inserted into the mold 54 even after the mandrel has been brought into position.

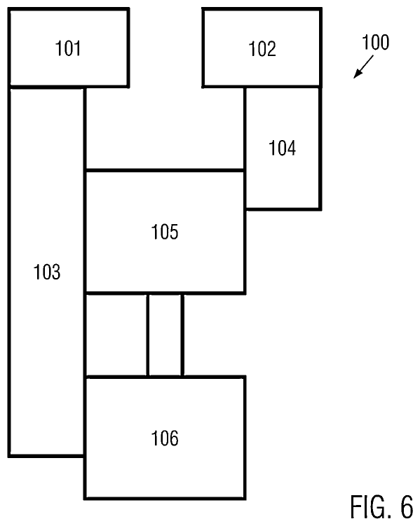

FIG. 6 shows a filling system 100, in particular a beverage filling system 100, with a first apparatus 101 for molding and pressing a closure in accordance with one of the above embodiments (e.g., the first apparatus 101 is a non-limiting example of any of the apparatuses illustrated in FIGS. 1-5C). Furthermore, the filling system 100 comprises a second apparatus 102 for molding and pressing a container, a first transport apparatus 103 and a filling device 105 for filling the containers. The filling system 100 also comprises a third apparatus 106 for applying the closure 13, 57 to the container. In addition, the filling system 100 may comprise a second transport apparatus for transporting the containers from the second apparatus 102 to the filling device 105. The first transport apparatus 103 can be configured to transport the closures 13 from the first apparatus 101 to the third apparatus 106. Furthermore, the filling system may comprise a further transport apparatus for transporting the filled containers to the third apparatus 106. Alternatively, it is also possible to arrange the third apparatus 106 directly on the filling device 105. Furthermore, it is possible to arrange coating devices not shown along the first and second transport apparatus in order to coat the closures 113 or containers, in particular their respective inner sides. The first apparatus 101 for molding and pressing a closure and the second apparatus 102 for molding and pressing a container may obtain their respective material from the same source if both the closure 113 and associated container are molded and pressed from the same material.

1. An apparatus for molding and pressing a closure comprising fibers, wherein the apparatus comprises:
a mold in which the closure is to be at least partially molded and which has an opening,
a mandrel, at least temporarily and/or partially within the mold, the mandrel comprising a structure for molding the closure, and
movement means for executing a relative movement between the mold and the mandrel to reduce a clearance of the mold and the mandrel, and thus to form and press the closure.

2. The apparatus according to claim 1, wherein the structure comprises a negative mold of a thread to be molded, and/or of engagement elements to be molded.

3. The apparatus according to claim 1, wherein the relative movement comprises a movement of the mold in a direction toward the mandrel or in a direction away from the mandrel.

4. The apparatus according to claim 1, wherein the relative movement comprises a movement of the mandrel in a direction toward the mold or in a direction away from the mold.

5. The apparatus according to claim 1, wherein the mold comprises a structured lateral surface in the form of elevations and/or depressions.

6. The apparatus according to claim 5, wherein the mandrel or the mold comprises at least two radially movable jaws.

7. The apparatus according to claim 6, wherein respectively at least one inclined plane is provided on a rear side of the structured lateral surface, and the movement means comprises a spreading rod or expansion sleeve of the mold or the mandrel that is movable parallel to a longitudinal axis of the mandrel, wherein an interaction of the at least one inclined plane and the spreading rod or expansion sleeve is configured to produce a radial movement of the at least two radially movable jaws.

8. The apparatus according to claim 6, wherein the movement means comprises a hydraulic system which, in interaction with the at least two radially movable jaws, is configured to produce a radial movement of the at least two radially movable jaws.

9. The apparatus according to claim 1, wherein the movement means comprises at least one radially movable jaw and at least one toggle lever, wherein an interaction of the at least one toggle lever and the at least one radially movable jaw is configured to produce a radial movement of the at least one radially movable jaw.

10. The apparatus according to claim 1, further comprising rotary means for executing a rotation of the mandrel or the mold about its longitudinal axis.

11. A method for molding and pressing a closure comprising fibers, the method comprising:
providing the closure comprising fibers at least partially in a mold, the mold comprising an opening in which a mandrel is arranged at least temporarily and/or partially,
optionally inserting the mandrel into the opening, and
executing a relative movement between the mold and the mandrel using a movement means to reduce a clearance of the mold and the mandrel, and thereby molding and pressing the closure.

12. The method according to claim 11, wherein the execution of the relative movement to reduce the clearance comprises:
moving the mold, using the movement means, radially in a direction of the mandrel, wherein the mandrel is stationary, or
moving the mandrel, using the movement means, in a direction of the mold, wherein the mold is stationary, or
moving the mold, using the movement means, in a direction of the mandrel, and moving the mandrel, using the movement means, in a direction of the mold.

13. The method according to claim 11, further comprising moving radially movable jaws of the mandrel away from a longitudinal axis of the mandrel or moving radially movable jaws of the mold towards a longitudinal axis of the mandrel.

14. The method according to claim 13, further comprising rotating the mandrel or mold through an angle.

15. The method according to claim 11, further comprising, after molding and pressing the closure, moving the mold away from a longitudinal axis of the mandrel and/or moving radially movable jaws of the mandrel toward the longitudinal axis of the mandrel, if the mandrel comprises radially movable jaws.

16. A filling system, comprising:
a first apparatus for molding and pressing a closure comprising fibers, the first apparatus comprising a mold in which the closure is to be at least partially molded and which has an opening, a mandrel at least temporarily and/or partially within the mold, the mandrel comprising a structure for molding the closure, and movement means for executing a relative movement between the mold and the mandrel to reduce a clearance of the mold and the mandrel, and thus to form and press the closure,
a second apparatus for molding and pressing a container comprising fibers,
a transport apparatus for transporting the closure;
a filling device for filling the container with a liquid, and
a third apparatus for applying the closure to the container.

17. The apparatus according to claim 6, wherein the at least two radially movable jaws comprise two radially movable jaws, which in each case comprise a cylinder segment of 180°, or wherein the at least two radially movable jaws comprise four radially movable jaws, which in each case comprise a cylinder segment of 90°.

18. The apparatus according to claim 1, wherein the mandrel is configured for insertion into the opening of the mold and the relative movement comprises a radial relative movement with respect to a longitudinal axis of the mandrel.
